(19) United States
(12) Patent Application Publication
(10) Pub. No.: US 2010/0082542 A1
(43) Pub. Date: Apr. 1, 2010

(54) COMPARISON OF ONLINE ADVERTISING DATA CONSISTENCY

(75) Inventors: Andrew Feng, Cupertino, CA (US); Rohit Chandra, Los Altos, CA (US); Srihari Venkatesan, Burbank, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/242,502

(22) Filed: Sep. 30, 2008

(51) Int. Cl. G06F 17/30

(52) U.S. Cl. 707/639; 707/E17.044

(57) ABSTRACT

The subject matter disclosed herein relates to initiating a comparison of a source snapshot including current source advertising data with a destination snapshot including current destination advertising data taken at the same logical time as such a source snapshot.

### BACKGROUND

1. Field

The subject matter disclosed herein relates to data processing, and more particularly to processing data associated with online advertising and/or other like aspects of shared network resources.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new “online” information seemingly being added every second. With so much information being available online, advertising via the Internet and/or other like online network resources may allow advertisers to target the audience viewing certain types of information with related and/or other potentially applicable advertisements.

The success of online advertising campaigns may involve making efficient use of an advertising budget with the desire to influence audience behavior in some manner. For example, if an online advertising campaign is directed to selling a product, then the advertiser may seek to use a given budget to purchase advertising to cause as many consumers to purchase the product as possible at a minimal cost. Determining how to efficiently spend an advertising budget, as well as implementing and managing an ongoing advertising campaign (or campaigns) utilizing such a budget, however, can pose a daunting challenge to advertisers. Accordingly, online advertising campaigns may regularly and/or quickly be modified and/or adjusted in order to more efficiently spend an advertising budget.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a flow diagram showing a process for auditing of online advertising data in accordance with one or more embodiments.

FIG. 2 is a flow diagram showing a process for auditing of online advertising data in accordance with one or more embodiments.

FIG. 3 is a block diagram illustrating an exemplary embodiment of a computing environment system in accordance with one or more embodiments.

FIG. 4 is a flow diagram showing a process for generating a source snapshot in accordance with one or more embodiments.

FIG. 5 is a flow diagram showing a process for generating a destination snapshot in accordance with one or more embodiments.

FIG. 6 is a block diagram illustrating an exemplary embodiment of a system for distribution of advertising data in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

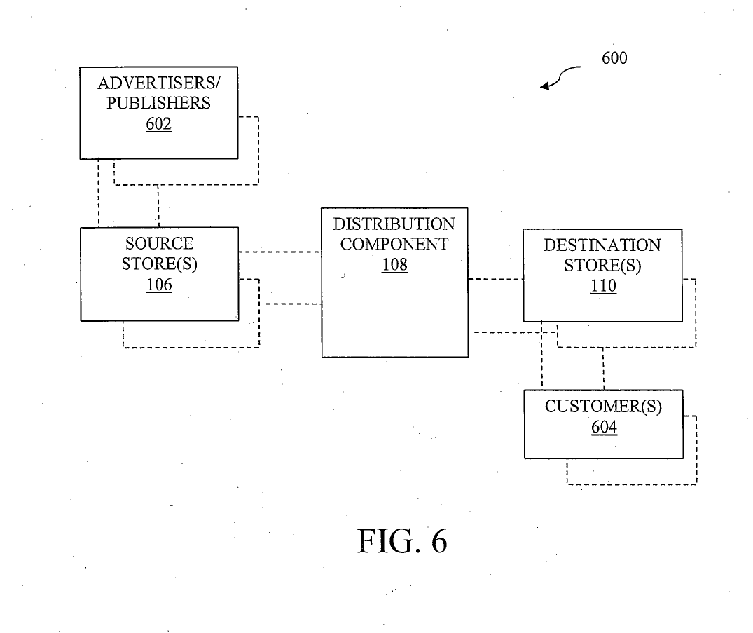

As discussed above, determining how to efficiently spend an advertising budget, as well as implementing and managing an ongoing advertising campaign (or campaigns) utilizing such a budget, however, can pose a daunting challenge to advertisers. In response, online advertising campaigns may regularly and/or quickly be modified in order to more efficiently spend an advertising budget. Referring to FIG. 6, for example, one or more advertisers/publishers 602 may alter and/or update online advertising data modifying one or more source stores 106, and these changes may be propagated to serving systems (referred to herein as destination stores 110). Accordingly, consistency of modified online advertising data placed in a source store 106 as compared with online advertising data in destination stores 110 may be difficult to accurately audit in view of regular and/or quick modifications to such online advertising data. As will be described in greater detail below, multiple source stores 106 may be modified by advertisers/publishers 602. Such modifications may be communicated from multiple source stores 106 to multiple destination stores 110 via a distribution component 108. Likewise, multiple destination stores 110 may communicate with multiple customers 604, such as by communicating online advertising data to such customers 604.

As used herein, the term “source store” may refer to one or more data stores that may be modified by advertisers and/or publishers 602. For example, a source store 106 may be operative to receive online data from one or more advertisers. Such online data may include online advertising data and/or may include other types of online data not limited to online advertising data. Many of the example embodiments described herein are described in terms of use in conjunction with online advertising data; however, it will be understood that such procedures may be equally applicable to other types of online data, and may not be limited to online advertising data. Such online advertising data may include text, graphic or video data, and/or the like (herein referred to as “creative data”) related to at least one ad. Additionally, online advertising data may include metadata and/or rules associated with a set of creative data. For example, for a given ad, an advertiser 602 may transmit and/or otherwise provide a graphical banner ad as well as text associated with the banner ad and/or the like (e.g., a caption or similar form of text). Additionally or alternatively, an advertiser 602 may transmit and/or otherwise provide metadata associated with such a banner ad including, but not limited to, keywords associated with the ad, and/or a time period to display the ad. Additionally or alternatively, a source store 106 may be operative to receive and/or otherwise access online advertising data from and/or associated with one or more publishers 602. For example, such publishers 602 may include website providers who may subscribe to an advertising service in order to provide advertisements. Such online advertising data may include one or more constraints and/or rules capable of use in determining advertisements that may be displayed on content pages of a publisher's website. For example, a publisher 602 may specify one or more terms that may serve as a basis for excluding an advertisement (e.g., offensive content) and/or may specify one or more advertisers to be excluded.

As used herein, the term “content page” may include any information in a digital format, of which at least a portion may be perceived in some manner (e.g., visually, audibly) by a user if reproduced by a digital device, such as, for example, a computing platform. For one or more embodiments, a content page may comprise a web page coded in a markup language, such as, for example, HTML (hypertext markup language), and/or the like. However, the scope of claimed subject matter is not limited in this respect. Also, for one or more embodiments, the content page may comprise one or more elements. The elements in one or more embodiments may comprise text, for example, as may be displayed as part of a web page presentation. Also, for one or more embodiments, the elements may comprise a graphical object, such as, for example, a digital image. Unless specifically stated, a content page may refer to either the source code for a particular web page or the web page itself. Each web page may contain embedded references to images, audio, video, other web documents, etc. One common type of reference used to identify and locate resources on the web is a Uniform Resource Locator (URL).

As used herein, the term “destination store” may refer to one or more data stores that may be operative to store one or more rules related to serving advertising content. In one example embodiment, such a destination store 110 may be operative to store one or more rules associating one or more ads with one or more advertisers and/or one or more advertisements with one or more publishers. Such a destination store 110 may include a relational database, and/or the like, which may be capable of storing one or more relationships between one or more rules and one or more advertisements, for example.

A data warehouse may be maintained to track online advertising data from one or more source stores 106. Such data warehouse may, for example, be separate from one or more source stores 106. Individual source stores 106 may routinely update a data warehouse. e.g., in batches, such as several times a day, which may help to minimize the impact on advertiser access to individual source store(s) 106. Likewise, individual destination stores 110 may update such a separate data warehouse in batches. An audit comparing source store 106 batches to destination store 110 batches may be made.

However, in certain situations, such an audit may be less effective. For example, an audit may be less effective if the source stores 106 and/or destination stores 110 are geographically distributed. For example, source stores 106 may be distributed in different locations around the world to operate in conjunction with geographically dispersed customers, advertisers, advertising channels, publishers, and/or marketplace operators, and/or the like. Likewise, destination stores 110 may be distributed in different locations around the world to operate in conjunction with geographically dispersed advertising channels. As used herein, the term “advertising channel” may include particular entities, organizations, or the like, that facilitate distribution of ads for advertised products, services and/or content of advertisers. Thus, such a configuration may increase the complexity of gathering and comparing source store 106 batches to destination store 110 batches.

Additionally, not all destination stores 110 may necessarily be updated if a modification is made at a given source store 106. For example, distribution component 108 may be operative to collect online advertising data or modifications thereto from such source stores 106 and to distribute collected online advertising data to geographically and/or otherwise distributed destination stores 110. Such a distribution component 108 may be operative to determine which destination stores 110 need to receive the updated online advertising data. For example, such a distribution component 108 may update only U.S.-based destination stores 110 if the updated online advertising data indicates that the given ads are to be run in the United States (U.S.) market only. Alternatively, such a distribution component 108 may update both U.S.-based and European-based destination stores 110, respectively, if the updated online advertising data indicates that the given ads are to be run in both the U.S. and European markets.

Further, an audit may be less effective if the online advertising data from a given destination store 110 is not easily comparable with information from a given source store 106. Online advertising data from source stores 106 may be propagated to destination stores 110. For example, such a distribution component 108 may collect online advertising data from source stores 106 and may distribute collected online advertising data distributed destination stores 110. In such a case, online advertising data from a given destination store 110 may have undergone a data transformation and/or translation and may not be directly comparable with information from a given source store 106. For example, such a data transformation may involve data being split, dropped, and/or changed in a representational format. Such a data transformation may have been introduced by such a distribution component 108. Additionally or alternatively, data models on destination stores 110 need not be the same as data models on source stores 106.

In yet another example, an audit may be less effective if there may be a built-in delay between when online advertising data appears in a given source store 106 and when that same online advertising data is propagated to a given destination store 110. For example, such built-in delays may occur in cases where a distribution component 108 may collect online advertising data from source stores 106 and may distribute collected online advertising data distributed destination stores 110. Accordingly, a false identification of a mismatch in online advertising data between source stores 106 and destination stores 110 may occur due to a time delay in updating such destination stores 110. Similarly, online advertising data may be modified in source stores 106 at a rate that may elude detection by a routine update to a separate data warehouse. In such a case; however, such a modification may be detected by a routine update by a given destination source to such a separate data warehouse, due to such a time delay in updating such destination stores 110. Accordingly, it may not be trivial to identify when a mismatch in online advertising data between source stores 106 and destination stores 110 is merely due to a time delay in updating such destination stores 110. Accordingly, another false identification of a mismatch in online advertising data between source stores 106 and destination stores 110 may occur due to a time delay in updating such destination stores 110.

Accordingly, some exemplary methods and systems are described herein that may be used to monitor the consistency of modified online advertising data placed in one or more source stores 106 as compared with online advertising data in destination stores 110. As will be described in greater detail below, certain exemplary embodiments described herein may provide mechanisms to more accurately audit online advertising data in source stores 106 and/or destination stores 110 in view of regular and/or quick modifications to such online advertising data. For example, a comparison may be made between source stores 106 and/or destination stores 110 so as to ensure that source stores 106 and destination stores 110 have both applied the same set of updates.

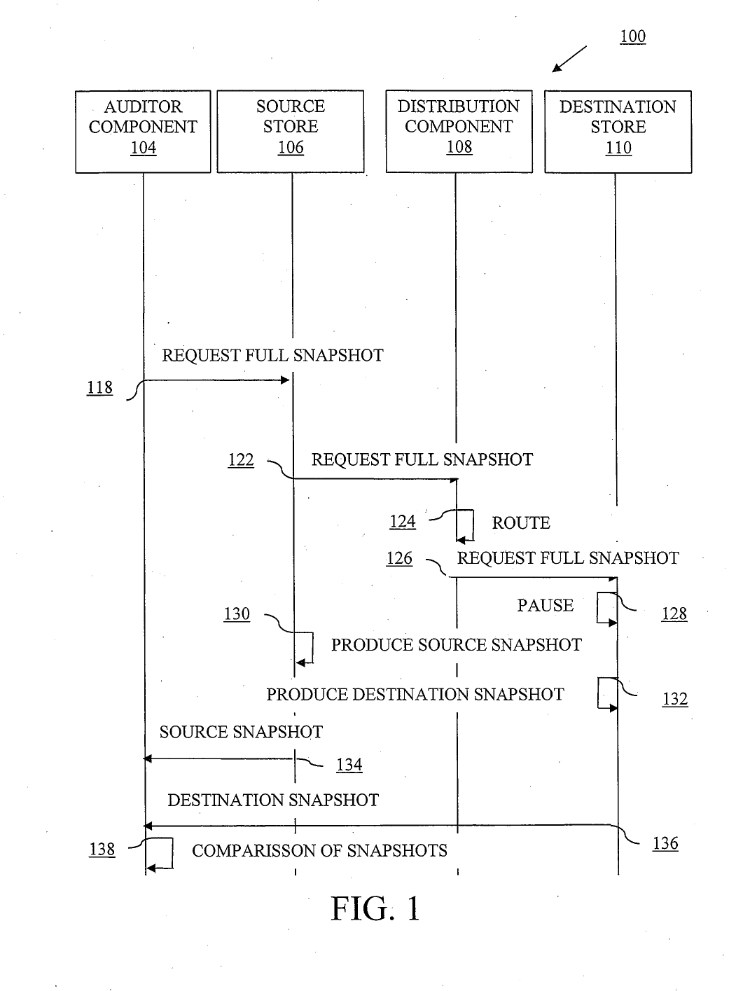

Referring to FIG. 1, a flow diagram illustrates a process for auditing of online advertising data in accordance with one or more embodiments. Although process 100, as shown in FIG. 1, comprises one particular order of actions, the order in which the actions are presented does not necessarily limit claimed subject matter to any particular order. Likewise, intervening actions not shown in FIG. 1 and/or additional actions not shown in FIG. 1 may be employed and/or actions shown in FIG. 1 may be eliminated, without departing from the scope of claimed subject matter.

Audit process 100 depicted in FIG. 1 may in certain embodiments be implemented in software, hardware, and/or firmware, and may comprise discrete operations. In the illustrated embodiment, an auditor component 104 may be coupled in communication with one or more source stores 106 and one or more destination stores 110. For example, as discussed above, source store 106 may refer to a data store that may be modified by advertisers and/or publishers 602. Further, destination store 110 may refer to a data store that may be operative to store rules related to serving advertising content, for example. Additionally, a distribution component 108 may be associated with such source stores 106 and such destination stores 110. For example, as discussed above, distribution component 108 may be operative to collect online advertising data or modifications thereto from such source stores and to distribute collected online advertising data to geographically distributed destination stores.

Such a request for a snapshot may provide a message to both source store 106 as well as destination store 110. As illustrated at action 118, a request for a full snapshot may be sent from auditor component 104 to source store 106. For example, a request for a full snapshot message may be sent from auditor component 104 to one or more source stores 106. Such a request for a full snapshot message may instruct at least one of such source stores 106 to produce a source snapshot. Such a source snapshot may include current source online advertising data from source store 106. In one example, such an instruction may be applied to all source stores 106 in a set of source stores.

At source store 106, when a request for a full snapshot message is received, source store 106 may continue further updates, send a corresponding request for a snapshot message to one or more destination stores 110 via distribution component 108, and then send a resultant source snapshot to auditor component 104.

As illustrated at action 122, such a request for a full snapshot message to source stores 106 may instruct at least one of such source stores 106 to forward and/or otherwise provide such a request for a full snapshot message to destination stores 110. For example, a request for a full snapshot message may be sent to destination store 110 from auditor component 104 through distribution component 108 via at least one of such source stores 106. In one example, such an instruction may be applied to all source stores 106 in a set of source stores. As illustrated at action 124, distribution component 108 may determine which of the destination stores 110 should receive updated online advertising data from source stores 106. Based at least in part on such a determination, one or more of destination stores 110 may be targeted to receive such a request for a full snapshot.

As illustrated at action 126, such a request for a full snapshot message may be sent from auditor component 104 to destination store 110, such as via distribution component 108, for example. Such a request for a full snapshot message may be sent from auditor component 104 to destination store 110 without necessarily relying on distribution component 108. Such a request for a full snapshot message may be sent from auditor component 104 to one or more destination stores 110. Such a request for a full snapshot message may instruct at least one of such destination stores 110 to produce a destination snapshot. Such a destination snapshot may include current destination online advertising from destination store 110. In one example, such an instruction may be applied to all destination stores 110 in a set of destination stores.

At destination store 110, when a request for a full snapshot message is received, destination store 110 may place a hold on new updates, complete pending updates, send a resultant destination snapshot to auditor component 104, and then resume updates. As illustrated at action 128, such a request for a full snapshot message may instruct at least one of destination stores 110 to pause further updates to such destination online advertising data. In one example, such an instruction may be applied to all destination stores 110 in a set of destination stores.

As illustrated at action 130, a source snapshot may be produced based at least in part on such source online advertising data. For example, such a request for a full snapshot message to source stores 106 may instruct at least one of source stores 106 to complete pending updates to such source online advertising data to provide current source online advertising data for use in such a source snapshot. In one example, such an instruction may be applied to all source stores 106 in a set of source stores.

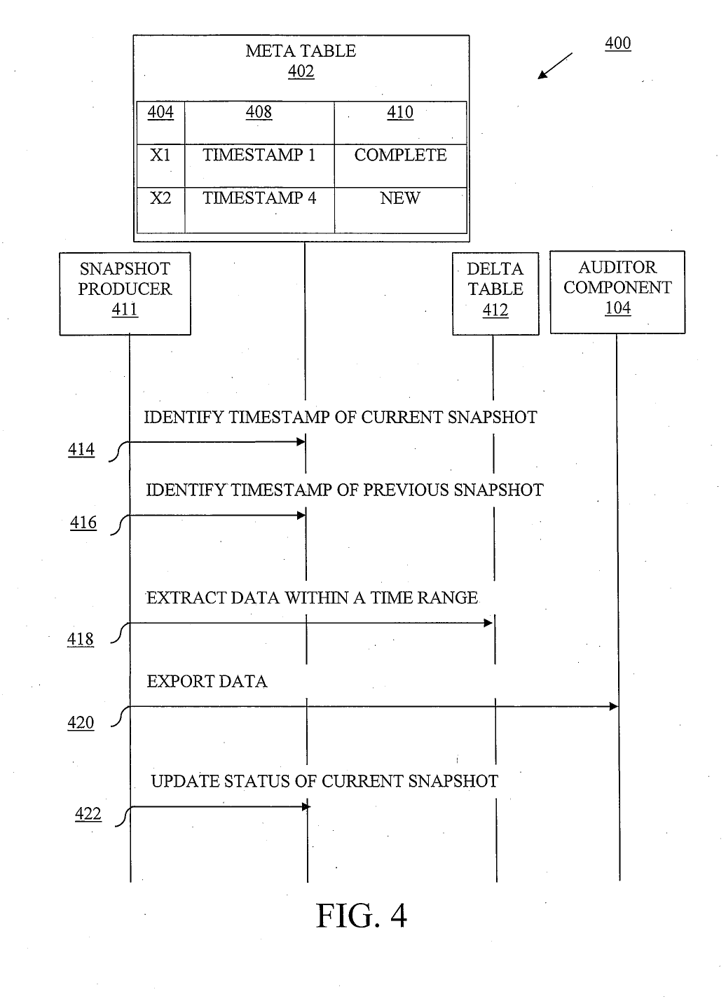

Referring to FIG. 4, a flow diagram illustrates a process for generating a source snapshot in accordance with one or more embodiments. Audit process 400 depicted in FIG. 4 may in certain embodiments be implemented in software, hardware, and/or firmware, and may comprise discrete operations. In the illustrated embodiment, such a source snapshot may be produced based at least in part on one or more snapshot meta tables 402 and/or one or more delta tables 412. Such meta tables 402 may be associated with a source store 106 (FIG. 1) via a snapshot producer 411 in order to track when a given request for a snapshot has been received and/or completed. For example, such a meta table 402 may associate snapshots via identification 404 with one or more time stamps 408 and/or one or more status codes 410. Such meta data information, including but not limited to identification 404, time stamps 408, and/or status codes 410, may be utilized, as will be described in greater detail below, in producing a source snapshot. Likewise, such delta tables 412 may contain modifications (such as additions, alterations, and/or deletions) to source online advertising data.

As illustrated at action 414, a timestamp of a given request for a snapshot may be identified. For example, a timestamp of a current request for a snapshot may be stored in meta table 402. As illustrated, timestamp 4 may identify when a current request for a snapshot X2 was received.

As illustrated at action 416, a timestamp of a given request for a snapshot may be identified. For example, a timestamp of a previous request for a snapshot may be identified from meta table 402. As illustrated, timestamp 1 may identify when a previous request for a snapshot X1 was completed.

As illustrated at action 418, online advertising data for a source snapshot may be extracted based at least in part on a given time range. For example, such a time range may be determined based at least in part on a timestamp of a current and/or on a timestamp of previous request for a snapshot. As illustrated, such a time range may be between timestamp 4 of when a current request for a snapshot X2 was received and when a previous request for a snapshot X1 was completed. As illustrated at action 420, such extracted online advertising data may be exported to auditor component 104.

As illustrated at action 422, meta table 402 may be updated. For example, meta table 402 may be updated to reflect that the current request for a snapshot X2 was completed. Accordingly, such a current request for a snapshot may be then identified as the new previous request for a snapshot, when a subsequent request for a snapshot is received. In operation, meta data may be associated with such a request for a snapshot via meta table 402 associated with source store 106 (FIG. 1). In such a case, a snapshot producer 411 may determine at least a portion of online advertising data for inclusion in a source snapshot based at least in part on such meta data. Additionally or alternatively, such snapshot producers 411 may be invoked periodically and/or on demand. For example, such snapshot producers 411 may be invoked via a snapshot request from auditor component 104.

Referring back to FIG. 1, as illustrated at action 132, a destination snapshot may be produced based at least in part on such destination online advertising data. For example, such a request for a full snapshot message to destination stores 110 may instruct at least one of destination stores 110 to complete pending updates to such destination online advertising data to provide current destination online advertising data for use in such a destination snapshot. In one example, such an instruction may be applied to all destination stores 110 in a set of destination stores.

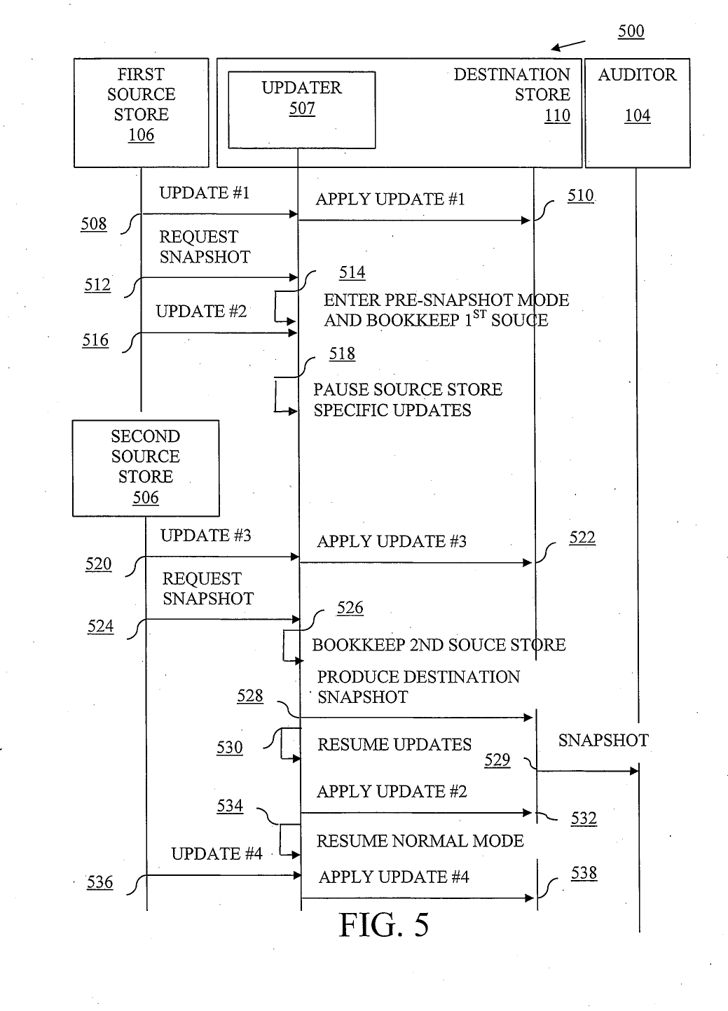

Referring to FIG. 5, a flow diagram illustrates a process for generating a destination snapshot in accordance with one or more embodiments. Audit process 500 depicted in FIG. 5 may in certain embodiments be implemented in software, hardware, and/or firmware, and may comprise discrete operations. In the illustrated embodiment, destination store 110 may receive request for a snapshot from one or more source stores 106/506. However, such requests for a snapshot from multiple source stores 106/506 may not arrive simultaneously. Accordingly, process 500 may be utilized to handle a non-simultaneous pausing of portions of updates to destination online advertising data.

As illustrated at action 508, first source store 106 may forward and/or otherwise provide a first update message to one or more updater modules 507 associated with one or more destination stores 110. In turn updater module 507 may forward and/or otherwise provide such a first update message such destination stores 110, at action 510.

As illustrated at action 512, first source store 106 may forward and/or otherwise provide a request for a snapshot message to one or more updater modules 507 associated with one or more destination stores 110. As illustrated at action 514, such a request for a snapshot message from first source store 106 may instruct updater module 507 to book-keep current destination online advertising data associated with first source store 106. Such “bookkeeping” may refer to identifying and/or tracking when snapshot messages are received and/or when a corresponding snapshot is produced on an individual source store basis. Additionally, such a request for a snapshot message from first source store 106 may instruct updater module 507 to enter a pre-snapshot mode. In such a mode, updater 507 may wait to produce a destination snapshot until a determination is made that a set of requests for a snapshot message is complete. For example, portions of destination online advertising data may be associated multiple source stores 106/506. In such a case, updater 507 may monitor when requests for a snapshot message have been receive from a set of associated multiple source stores 106/506. As will be discussed below, such a destination snapshot may be produced in cases where updater 507 has determined that a set of requests for a snapshot message is complete.

As illustrated at action 516, first source store 106 may forward and/or otherwise provide a second update message to one or more updater modules 507 associated with one or more destination stores 110. In turn updater module 507 may hold such a second update message, at action 518. For example, such a request for a snapshot message from first source store 106 may instruct updater module 507 to pause further updates to portions of destination online advertising data associated with first source store 106.

Similarly, as illustrated at action 520, second source store 506 may forward and/or otherwise provide a third update message to one or more updater modules 507 associated with one or more destination stores 110. In turn updater module 507 may forward and/or otherwise provide such a third update message such destination stores 110, at action 522. For example, in some cases, source store updates from first source store 106 may have been paused, while source store updates from second source store 506 may continue to operate.

Similarly, as illustrated at action 524, second source store 506 may forward and/or otherwise provide a request for a snapshot message to one or more updater modules 507 associated with one or more destination stores 110. As illustrated at action 526, such a request for a snapshot message from second source store 506 may instruct updater module 507 to book-keep current destination online advertising data associated with second source store 506. Additionally, such a request for a snapshot message from second source store 506 may instruct updater module 507 to pause further updates to portions of destination online advertising data associated with second source store 506. Accordingly, in some cases, updates associated with first source store 106 and updates associated with second source store 506 may be paused, such as while a destination snapshot is being produced. As illustrated at action 528, updater module 507 may produce a destination snapshot. For example, updater module 507 may determine that a set of requests for a snapshot message is complete. In such a case, updater module 507 may monitor when requests for a snapshot message have been receive from a set of associated multiple source stores 106/506. For instance, as illustrated at action 528, such a destination snapshot may be produced based at least in part on such destination online advertising data and forwarded to destination store 110. At action 529, such a destination snapshot may be forwarded from destination store 110 to auditor 104.

As illustrated at action 530, updater module 507 may resume further updates of destination online advertising data to destination store 110 after such a destination snapshot has been made. Such updates may be source store 106/506 dependent. For example, updater module 507 may resume further updates based on information regarding when updates destination online advertising data associated with first source store 106 were paused. Similarly, updater module 507 may resume further updates based on information regarding when updates destination online advertising data associated with second source store 506 were paused. In such a case, updater module 507 may resume further updates in such a way as to track back to updates that were paused at action 518 associated with first source store 106 and/or to track back to updates that were paused at action 526 associated with second source store 506. For example, as illustrated at action 532, updater module 507 may forward and/or otherwise provide such a second update message to destination stores 110.

At action 534, updater module 507 may cease the pre-snapshot mode and resume a normal mode of operation where updates from source stores 106/506 may be passed from updater module 507 to destination stores 110. For example, as illustrated at action 536, second source store 506 may forward and/or otherwise provide a fourth update message to one or more updater modules 507 associated with one or more destination stores 110. In turn updater module 507 may forward and/or otherwise provide such a first update message such destination stores 110, at action 538. In operation, a requests for a snapshot from a set of source stores may be tracked via one or more updater modules 507 associated with one or more destination stores 110. In such a case, updates from selected source stores 106/506 may be paused based at least in part on such tracked requests for a snapshot via updater modules 507. Additionally, updater modules 507 may resume such paused updates after a destination snapshot is produced.

Referring back to FIG. 1, as illustrated at action 134, such a request for a full snapshot message to source stores 106 may instruct at least one of such source stores 106 to send such a source snapshot including current source online advertising data to auditor component 104. Such a source snapshot may be received by auditor component 104. In one example, such an instruction may be applied to all source stores 106 in a set of source stores.

As illustrated at action 136, such a request for a full snapshot message to destination stores 110 may instruct at least one of such destination stores 110 to send such a destination snapshot including current destination online advertising data to auditor component 104. In one example, such an instruction may be applied to all destination stores 110 in a set of destination stores. Additionally or alternatively, such a request for a full snapshot message to destination stores 110 may instruct at least one of such destination stores 110 to resume further updates to destination online advertising data after such a destination snapshot has been made. Such a destination snapshot may be received by auditor component 104. In one example, such an instruction may be applied to all destination stores 110 in a set of destination stores.

As illustrated at action 138, such a source snapshot may be compared with such a destination snapshot. Such a comparison may be utilized to ensure that source stores 106 and destination stores 110 have both applied the same set of updates. Additionally or alternatively, a subset of online advertising data may be determined that does not match between such a source snapshot and such a destination snapshot based at least in part on such a comparison. Additionally or alternatively, such a source snapshot and/or such a destination snapshot may be subject to a data transformation prior to such a comparison. Additionally or alternatively, cloud computing infrastructure and/or grid computing infrastructure (not shown) may be utilized to make potentially thousands of machines available for computations involved in audit process 100. Such cloud computing infrastructure and/or grid computing infrastructure may refer to a form of distributed computing whereby a virtual computer may be composed of a cluster of networked and/or coupled computers, which may act in concert to perform a communal task. For example, operations of data transformation and/or comparison of transformed data described above at action 138 may be performed based at least in part on cloud computing infrastructure and/or grid computing infrastructure, and/or the like.

In operation, audit process 100 may perform a fairly extensive audit. A request for a snapshot message may be formulated by auditor component 104. Audit process 100 may then take a snapshot of online advertising data at both source stores 106 and destination stores 110, as illustrated at actions 118-136. Such snapshots may be essentially taken at the same logical time at both source store 106 as well as at destination store 1 10. For example, based at least in part on the operations of placing holds on new updates at action 128 and/or completing pending updates at actions 130/132, so that such a destination snapshot and such a source snapshot may be associated with a specific logical time. For example, such a destination snapshot may include data taken at the same logical time as such a source snapshot. As used herein the phrase “at the same logical time” may refer to operating audit process 100 in such a way that a set of one or more updates that have been applied in source store 106 have also been made in destination store 110. In such a case, such operations may be utilized to ensure that updates may not be delayed from distribution component 108. Additionally, audit process 100 may be operatively enabled to reduce impacts on other possible operations. Accordingly, process 100, and/or other processes described herein, may be performed in the course of ongoing updates to source advertising data at source stores 106 and/or in the course of ongoing updates to destination advertising data at destination stores 110. For example, such processes may perform an audit of live source stores 106 and/or destination stores 110. In such a case, source stores 106 and/or destination stores 110 may be subject to updating with live updates in the course of such an audit.

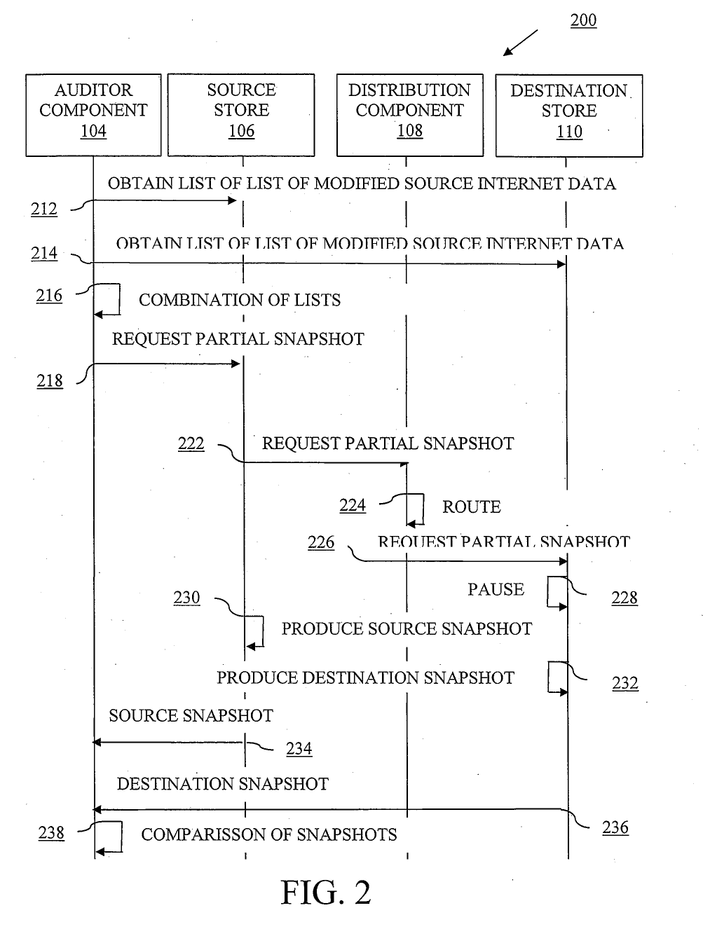

Referring to FIG. 2, a flow diagram illustrates another process for auditing of online advertising data in accordance with one or more embodiments. Audit process 200 may contain some similarities to audit process 100. In such cases, such similar operations may be briefly mentioned here, but may be more fully explained with reference to the corresponding description in FIG. 1.

As illustrated at action 212, audit component 104 may obtain a preliminary list of modified source online advertising data from one or more source stores 106. Such a list of modified source online advertising data may be done preliminarily, i.e. before a request for a snapshot, as it may form at least a partial basis for such a request. As illustrated at action 214, audit component 104 may obtain a preliminary list of modified destination online advertising data from one or more destination stores 110. For example, such modified source online advertising data may have been added, altered, and/or deleted within a given time period, such as within a time period running from a previous audit. For example, obtaining a preliminary list of modified source online advertising data may be a preset routine occurrence and/or may be initiated by auditor component 104 on a routine and/or non-routine basis.

As illustrated at action 216, auditor component 104 may determine a subset of recently modified online advertising data. For example, auditor component 104 may determine a subset of recently modified online advertising data based at least in part on combining such a preliminary list of modified source online advertising data with such a preliminary list of modified destination online advertising data. Additionally or alternatively, such a preliminary list of modified source online advertising data with such a preliminary list of modified destination online advertising data may be subject to a data transformation prior to such a combination. A request for a snapshot message may be formulated by auditor component 104. For example, a request for a “partial snapshot,” as referred to herein, may refer to a snapshot that may be based at least in part on such a subset of online advertising data that has been recently modified as identified in either a preliminary list of modified source online advertising data or a preliminary list of modified destination online advertising data.

Such a request for a partial snapshot message may be received by both source store 106 as well as destination store 110. As illustrated at action 218, a request for a partial snapshot message may be sent from auditor component 104 to source store 106. For example, a request for a partial snapshot message may be sent from auditor component 104 to one or more source stores 106. Such a request for a partial snapshot message may instruct at least one of such source stores 106 to produce a source snapshot based at least in part on such a subset of online advertising data that has been recently modified. Such a source snapshot may include current source online advertising data from source store 106 related to such a recently modified subset of online advertising data. In one example, such an instruction may be applied to all source stores 106 in a set of source stores.

At source store 106, when a message is received to get a snapshot, source store 106 may continue further updates, send a corresponding request for a snapshot message to one or more destination stores 110 via distribution component 108, and then dump information.

As illustrated at action 222, such a request to source stores 106 may instruct at least one of such source stores 106 to forward such a request for a partial snapshot message to destination stores 110. For example, a request for a partial snapshot message may be sent to destination store 110 from auditor component 104 through distribution component 108 via at least one such source stores 106. In one example, such an instruction may be applied to all source stores 106 in a set of source stores. As illustrated at action 224, distribution component 108 may determine which of destination stores 110 should receive updated online advertising data from source stores 106. Based at least in part on such a determination, one or more of destination stores 110 may be targeted to receive such a request for a partial snapshot message.

As illustrated at action 226, such a request for a partial snapshot message may be sent from auditor component 104 to destination store 110, such as via distribution component 108, for example. Such a request for a partial snapshot message may be sent from auditor component 104 to destination store 110 without necessarily relying on distribution component 108. Such a request for a partial snapshot message may be sent from auditor component 104 to one or more destination stores 1 10. Such a request for a partial snapshot message may instruct at least one of such destination stores 110 to produce a destination snapshot. Such a destination snapshot may include current destination online advertising from destination store 110 related to such a recently modified subset of online advertising data. In one example, such an instruction may be applied to all destination stores 110 in a set of destination stores.

At destination store 110, when a message is received to get a snapshot, destination store 110 may place a hold on new updates, complete pending updates, dump information, and then resume updates. As illustrated at action 228, such a request for a partial snapshot message to destination stores 110 may instruct at least one of destination stores 110 to pause further updates to such destination online advertising data. In one example, such an instruction may be applied to all destination stores 110 in a set of destination stores.

As illustrated at action 230, a source snapshot may be produced based at least in part on such source online advertising data. For example, such a request for a partial snapshot message to source stores 106 may instruct at least one of source stores 106 to complete pending updates to such source online advertising data to provide current source online advertising data for use in such a source snapshot. In one example, such an instruction may be applied to all source stores 106 in a set of source stores.

As illustrated at action 232, a destination snapshot may be produced based at least in part on such destination online advertising data. For example, such a request for a partial snapshot message to destination stores 110 may instruct at least one of destination stores 110 to complete pending updates to such destination online advertising data to provide current destination online advertising data for use in such a destination snapshot. In one example, such an instruction may be applied to all destination stores 110 in a set of destination stores.

As illustrated at action 234, such a request to source stores 106 may instruct at least one of such source stores 106 to send such a source snapshot including current source online advertising data to auditor component 104. Such a source snapshot may be received via auditor component 104. In one example, such an instruction may be applied to all source stores 106 in a set of source stores.

As illustrated at action 236, such a request to destination stores 110 may instruct at least one of such destination stores 110 to send such a destination snapshot including current destination online advertising data to auditor component 104. In one example, such an instruction may be applied to all destination stores 110 in a set of destination stores. Additionally or alternatively, such a request to destination stores 110 may instruct at least one of such destination stores 110 to resume further updates to destination online advertising data after such a destination snapshot has been made. Such a destination snapshot may be received via auditor component 104. In one example, such an instruction may be applied to all destination stores 110 in a set of destination stores.

As illustrated at action 238, such a source snapshot may be compared with such a destination snapshot. Additionally or alternatively, a subset of online advertising data may be determined that does not match between such a source snapshot and such a destination snapshot based at least in part on such a comparison. Additionally or alternatively, such a source snapshot and/or such a destination snapshot may be subject to a data transformation prior to such a comparison. Additionally or alternatively, cloud computing infrastructure and/or grid computing infrastructure (not shown) may be utilized to make potentially thousands of machines available for computations involved in audit process 200. For example, operations of data transformation and/or comparison of transformed data described above at action 238 may be performed based at least in part on cloud computing infrastructure and/or grid computing infrastructure, and/or the like.

In operation, audit process 200 may perform a more targeted audit by preliminarily establishing a baseline subset of online advertising data that has been recently modified between source stores 106 and destination stores 110, as illustrated at actions 212/214/216. A request for a snapshot message may be formulated by auditor component 104 based at least in part on such a subset of recently modified online advertising data. Audit process 200 may then augment such a preliminarily established baseline by taking a snapshot of such a subset of recently modified online advertising data at both source stores 106 and destination stores 110, as illustrated at actions 218-236. Such snapshots may be essentially taken at the same logical time at both source store 106 as well as at destination store 110. For example, based at least in part on the operations of placing holds on new updates at actions 228 and/or completing pending updates at actions 230/232, such a destination snapshot may include data taken at the same logical time as such a source snapshot. In such a case, such operations may be utilized to ensure that updates may not be delayed and/or stuck in a pipe from distribution component 108. Additionally, audit process 200 may be operated to not significantly impact running of applications and/or online serving operations.

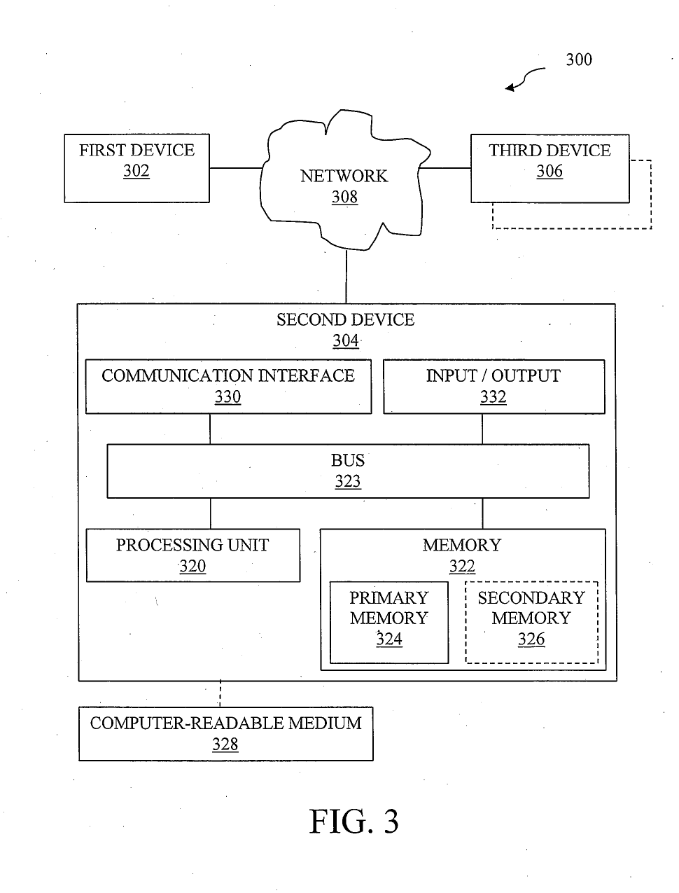

FIG. 3 is a block diagram illustrating an exemplary embodiment of a computing environment system 300 that may include one or more devices configurable to audit online advertising data using one or more techniques illustrated above, for example. For example, computing environment system 300 may be configurable to tangibly embody all or a portion of process 100 of FIG. 1 and/or process 200 of FIG. 2.

Computing environment system 300 may include, for example, a first device 302, a second device 304 and a third device 306, which may be operatively coupled together through a network 308.

First device 302, second device 304 and third device 306, as shown in FIG. 3, are each representative of any device, appliance or machine that may be configurable to exchange data over network 308. By way of example but not limitation, any of first device. 302, second device 304, or third device 306 may include: one or more computing platforms or devices, such as, e.g., a desktop computer, a laptop computer, a workstation, a server device, storage units, or the like.

Network 308, as shown in FIG. 3, is representative of one or more communication links, processes, and/or resources configurable to support the exchange of data between at least two of first device 302, second device 304, and third device 306. By way of example but not limitation, network 308 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 306, there may be additional like devices operatively coupled to network 308.

It is recognized that all or part of the various devices and networks shown in system 300, and the processes and methods as further described herein, may be implemented using or otherwise include hardware, firmware, software, or any combination thereof.

Thus, by way of example but not limitation, second device 304 may include at least one processing unit 320 that is operatively coupled to a memory 322 through a bus 323.

Processing unit 320 is representative of one or more circuits configurable to perform at least a portion of a data computing procedure or process. By way of example but not limitation, processing unit 320 may include one or more processors, controllers, microprocessors, microcontrollers, application specific integrated circuits, digital signal processors, programmable logic devices, field programmable gate arrays, and the like, or any combination thereof.

Memory 322 is representative of any data storage mechanism. Memory 322 may include, for example, a primary memory 324 and/or a secondary memory 326. Primary memory 324 may include, for example, a random access memory, read only memory, etc. While illustrated in this example as being separate from processing unit 320, it should be understood that all or part of primary memory 324 may be provided within or otherwise co-located/coupled with processing unit 320.

Secondary memory 326 may include, for example, the same or similar type of memory as primary memory and/or one or more data storage devices or systems, such as, for example, a disk drive, an optical disc drive, a tape drive, a solid state memory drive, etc. In certain implementations, secondary memory 326 may be operatively receptive of, or otherwise configurable to couple to, a computer-readable medium 328. Computer-readable medium 328 may include, for example, any medium that can carry and/or make accessible data, code and/or instructions for one or more of the devices in system 300.

Second device 304 may include, for example, a communication interface 330 that provides for or otherwise supports the operative coupling of second device 304 to at least network 308. By way of example but not limitation, communication interface 330 may include a network interface device or card, a modem, a router, a switch, a transceiver, and the like.

Second device 304 may include, for example, an input/output 332. Input/output 332 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 332 may include an operatively adapted display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

In one implementation, online advertising data from source stores and/or destination stores may be audited via a computing platform. Such auditing may be performed via a computing platform that manipulates or transforms electronic signals employed to represent physical electronic or magnetic quantities, or other physical quantities, within the computing platform's memories, registers, or other information storage, transmission, or display devices. For example, a computing platform may be operatively enabled to send a request for a snapshot message from an auditor component to two or more source stores. Such a computing platform may additionally be operatively enabled to send such a request for a snapshot message from such an auditor component to two or more destination stores. Such a computing platform may additionally be operatively enabled to compare such a source snapshot with such a destination snapshot and/or to determine a subset of online advertising data that does not match between such a source snapshot and such a destination snapshot.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method, comprising:
requesting a snapshot from one or more source stores;
receiving at least one source snapshot from at least one of said source stores, said source snapshot comprising source advertising data;
requesting a snapshot from one or more destination stores;
receiving at least one destination snapshot from at least one of said destination stores, said destination snapshot comprising destination advertising data, and wherein said source snapshot and said destination snapshot are associated with a specific logical time; and
comparing said source snapshot with said destination snapshot.

2. The method of claim 1, further comprising performing said method in the course of ongoing updates to said source advertising data at said one or more source stores and/or in the course of ongoing updates to said destination advertising data at said one or more destination stores.

3. The method of claim 1, further comprising determining a subset of advertising data that does not match between said source snapshot and said destination snapshot based at least in part on said comparison.

4. The method of claim 1, wherein said request for a snapshot is capable of being sent from said auditor component through a distribution component via at least one of said one or more source stores, wherein said distribution component is capable of determining which of said one or more destination stores are to receive updated advertising data from said one or more source stores.

5. The method of claim 1, further comprising:
receiving a preliminary list of modified source advertising data from said one or more source stores by said auditor;
receiving a preliminary list of modified destination advertising data from said one or more destination stores by said auditor; and
determining a subset of advertising data based at least in part on combining said preliminary list of modified source advertising data and said preliminary list of modified destination advertising data, and wherein said request for a snapshot is based at least in part on said subset of advertising data.

6. The method of claim 1, wherein said request for a snapshot is capable of instructing at least one of said one or more source stores to:
forward said request for a snapshot from said auditor component to one or more destination stores; and
send said source snapshot comprising current source advertising data to said auditor component

7. The method of claim 1, wherein said request for a snapshot is capable of instructing at least one of said one or more destination stores to:
pause further updates to said destination advertising data;
complete pending updates to said destination advertising data;
send said destination snapshot comprising current destination advertising data to said auditor component; and
resume said further updates to said destination advertising data.

8. The method of claim 1, further comprising:
wherein said request for a snapshot is capable of instructing at least one of said one or more source stores to: forward said request for a snapshot from said auditor component to one or more destination stores, and send said source snapshot comprising current source advertising data to said auditor component; and
wherein said request for a snapshot is capable of instructing at least one of said one or more destination stores to: pause further updates to said destination advertising data, complete pending updates to said destination advertising data, send said destination snapshot comprising current destination advertising data to said auditor component, and resume said further updates to said destination advertising data.

9. The method of claim 1, further comprising:
associating meta data with said request for a snapshot via said one or more source stores, wherein said meta data comprises an identification of said request for a snapshot, a time stamp, and a status code; and
determining at least a portion of online advertising data for inclusion in said source snapshot based at least in part on said meta data via one or more snapshot producers associated with said one or more source stores, and wherein said one or more snapshot producers may be invoked periodically and/or on demand.

10. The method of claim 1, further comprising:
tracking said requests for a snapshot from said one or more source stores via one or more updater modules associated with said one or more destination stores;
pausing updates to said one or more destination stores from selected source stores based at least in part on said tracked requests for a snapshot via one or more updater modules; and
resuming said paused updates after a destination snapshot is produced via one or more updater modules.

11. The method of claim 1, further comprising:
receiving a preliminary list of modified source advertising data from said one or more source stores by said auditor;
receiving a preliminary list of modified destination advertising data from said one or more destination stores by said auditor;
determining a subset of advertising data based at least in part on combining said preliminary list of modified source advertising data and said preliminary list of modified destination advertising data, and wherein said request for a snapshot is based at least in part on said subset of advertising data;
wherein said request for a snapshot is capable of instructing at least one of said one or more source stores to: forward said request for a snapshot from said auditor component to one or more destination stores, and send said source snapshot comprising current source advertising data to said auditor component; and
wherein said request for a snapshot is capable of instructing at least one of said one or more destination stores to: pause further updates to said destination advertising data, complete pending updates to said destination advertising data, send said destination snapshot comprising current destination advertising data to said auditor component, and resume said further updates to said destination advertising data.

12. An article comprising:
a storage medium comprising machine-readable instructions stored thereon which, if executed by one or more processing units, operatively enable a computing platform to:
request a snapshot from one or more source stores;
receive at least one source snapshot from at least one of said source stores, said source snapshot comprising source advertising data;
request a snapshot from one or more destination stores;
receive at least one destination snapshot from at least one of said destination stores, said destination snapshot comprising destination advertising data, and wherein said source snapshot and said destination snapshot are associated with a specific logical time; and
compare said source snapshot with said destination snapshot.

13. The article of claim 12, wherein said machine-readable instructions, if executed by the one or more processing units, operatively enable the computing platform to
receive a preliminary list of modified source advertising data from said one or more source stores by said auditor;
receive a preliminary list of modified destination advertising data from said one or more destination stores by said auditor; and
determine a subset of advertising data based at least in part on a combination of said preliminary list of modified source advertising data and said preliminary list of modified destination advertising data, and wherein said request for a snapshot is based at least in part on said subset of advertising data.

14. The article of claim 12, wherein said request to said one or more source stores is capable of instructing at least one of said one or more source stores to:
forward said request for a snapshot from said auditor component to one or more destination stores; and
send said source snapshot comprising current source advertising data to said auditor component.

15. The article of claim 12, wherein said request to said one or more destination store is capable of instructing at least one of said one or more destination stores to:
pause further updates to said destination advertising data;
complete pending updates to said destination advertising data;
send said destination snapshot comprising current destination advertising data to said auditor component; and
resume said further updates to said destination advertising data.

16. An apparatus comprising:
a computing platform, said computing platform being operatively enabled to:
request a snapshot from one or more source stores;
receive at least one source snapshot from at least one of said source stores, said source snapshot comprising source data;
request a snapshot from one or more destination stores;
receive at least one destination snapshot from at least one of said destination stores, said destination snapshot comprising destination data, and wherein said source snapshot and said destination snapshot are associated with a specific logical time; and
compare said source snapshot with said destination snapshot.

17. The apparatus of claim 16, wherein said computing platform is further operatively enabled to:
determine a subset of data that does not match between said source snapshot and said destination snapshot based at least in part on said comparison.

18. The apparatus of claim 16, wherein said computing platform is further operatively enabled to:
receive a preliminary list of modified source data from said one or more source stores by said auditor;
receive a preliminary list of modified destination data from said one or more destination stores by said auditor; and
determine a subset of data based at least in part on a combination of said preliminary list of modified source data and said preliminary list of modified destination data, and wherein said request for a snapshot is based at least in part on said subset of data.

19. The apparatus of claim 16, wherein said request to said one or more source stores is capable of instructing at least one of said one or more source stores to:
forward said request for a snapshot from said auditor component to one or more destination stores; and
send said source snapshot comprising current source data to said auditor component.

20. The apparatus of claim 16, wherein said request to said one or more destination store is capable of instructing at least one of said one or more destination stores to:
pause further updates to said destination data;
complete pending updates to said destination data;
send said destination snapshot comprising current destination data to said auditor component; and
resume said further updates to said destination data.
